(19) United States
(12) Patent Application Publication
(10) Pub. No.: US 2019/0061557 A1
(43) Pub. Date: Feb. 28, 2019

(54) ELECTRIC VEHICLE INTERFACES AND CONTROL SYSTEMS

(71) Applicant: Globe International Nominees Pty Ltd, Port Melboune, Victoria (AU)

(72) Inventors: Duncan Quick, Snake Valley, Victoria (AU); Peter Hill, Port Melbourne, Victoria (AU)

(21) Appl. No.: 15/771,996

(22) PCT Filed: Nov. 9, 2016
(86) PCT No.: PCT/IB2016/001960

§ 371 Date: Apr. 27, 2018

Related U.S. Application Data
(60) Provisional application No. 62/253,635, filed on Nov. 10, 2015.

(51) Int. Cl. B60L 15/00; B60L 11/18; A63C 17/12; B60K 35/00; A63C 17/01; H02P 6/08; H02P 6/12

(52) U.S. Cl. CPC B60L 15/00; B60L 11/18; A63C 17/12; B60K 35/00; A63C 17/01; A63C 17/017; B29D 11/00663; H02P 6/12; B60L 2200/24; A63C 2203/12; A63C 2203/18; A63C 2203/42; A63C 2203/24; H02P 6/08

(57) ABSTRACT

According to this disclosure, a control system for an electric vehicle includes an electronic speed controller (ESC) configured to control an electric motor operably connected to a wheel of the electric vehicle and an electric vehicle controller configured to monitor an operating characteristic of the electric motor, wherein the operating characteristic comprises a voltage, current, or frequency of the electric motor. The electric vehicle controller can he configured to determine at least one user input based on the operating characteristic of the electric motor. The user input can be indicative of acceleration, constant speed, or deceleration. The electric vehicle controller can be configured to send a signal to the electronic speed controller for the electronic speed controller to control the electric motor based on the determined user input.

### INCORPORATION BY REFERENCE TO ANY PRIORITY APPLICATIONS

This application claims priority to U.S. Provisional Application No. 62/253,635, filed Nov. 10, 2015, which is incorporated herein by reference in its entirety for all purposes and made a part of this specification. This application is related to Patent Cooperation Treaty (PCT) Application Nos. PCT/IB2016/000536, filed Apr. 8, 2016, and PCT/US2016/056919, filed Oct. 13, 2016, each of which is also incorporated herein by reference in its entirety for all purposes and made a part of this specification.

### BACKGROUND

### Field

This disclosure relates to electric vehicles. In particular, this disclosure relates to controlling an electric vehicle.

### Description

Lightweight personal vehicles, such as skateboards, scooters, roller skates, and others are common for recreational use and transportation. These vehicles are commonly non-motorized, requiring the user to provide the power for motion. Several motorized personal vehicles have been developed. For example, some motorized skateboards use a motor and a toothed belt to drive one or two wheels. As another example, some motorized skateboards include motorized wheels with hub-mounted motors.

Some existing motorized skateboards use handheld remotes or remote controls that allow a rider to control acceleration and braking of the motorized skateboard. Use of handheld remotes prevents hands free operation of the motorized skateboard. Other existing motorized skateboards include deck-mounted pedals or pressure sensors that are used to control acceleration of the skateboard. Use of deck-mounted pedals or pressure sensors can prevent a user from taking a natural riding stance while using the motorized skateboard.

### SUMMARY

According to this disclosure, a control system for an electric vehicle includes one or more of the following: an electronic speed controller (ESC) configured to control an electric motor operably connected to a wheel of the electric vehicle; and/or an electric vehicle controller configured to monitor an operating characteristic of the electric motor, wherein the operating characteristic comprises a voltage, current, or frequency of the electric motor. The electric vehicle controller can be configured to determine at least one user input based on the operating characteristic of the electric motor. The user input can be indicative of acceleration, maintaining constant speed, or deceleration of the electric vehicle. The electric vehicle controller can be configured to send a signal to the electronic speed controller for the electronic speed controller to control the electric motor based on the determined user input.

According to this disclosure, the control system can further include one or more of the following: the electric vehicle controller is capable of determining at least one user input based on at least one of an average rate of change of speed of the wheel or a frequency of change of speed of the wheel; the electric vehicle controller is connected to the electric motor to measure a back electromotive force (EMF) of the electric motor, and wherein the at least one user input is determined based on the measured back EMF; at least one sensor connected to the electric vehicle controller, and wherein the at least one user input is determined based on an output of the sensor; the sensor is an accelerometer; a portable computer connection connected to the electric vehicle controller and configured to deliver an information or data signal to a portable computer, the information or data signal corresponding to operation information associated with the electric vehicle, wherein the portable computer is capable of communicating the operation information to a user; the operation information comprises at least one of battery power or speed of the electric vehicle; the electric vehicle comprises an electric skateboard; the user input comprises a user pushing against the ground or a support surface with a foot or a stick to accelerate or decelerate the electric vehicle; the user input comprises a plurality of pushes; the user input comprises a user dragging a foot or a stick on the ground, a support surface, or the wheel of the electric vehicle to decelerate the electric vehicle; the electric vehicle controller determines a velocity or acceleration set point based on the user input; the velocity or acceleration set point is proportionally related to a frequency of the user input; the velocity or acceleration set point is proportionally related to a number of user inputs; and/or a single controller comprises the electric vehicle controller and the electronic speed controller, such that the single controller is configured to control the electric motor and is further configured to monitor an operating characteristic of the electric motor and determine the at least one user input.

According to this disclosure, a control system for an electric vehicle includes one or more of the following: an electronic speed controller (ESC) configured to control an electric motor operably connected to a wheel of the electric vehicle; and/or an electric vehicle controller configured to send signals to the electronic speed controller for the electronic speed controller to control the electric motor. The electric vehicle controller can be configured to automatically power on using back electromotive force (EMF) generated by the electric motor when a user pushes the electric vehicle into motion from rest.

According to this disclosure, the control system can further include one or more of the following: the electric vehicle controller is configured to power on the electronic speed controller after the electric vehicle controller automatically powers on, and wherein the electronic speed controller is powered by the back EMF; after automatically powering on, the electric vehicle controller transitions to battery power; after powering on the electronic speed controller, the electric vehicle controller transitions the electronic speed controller to battery power; the electric motor generates back EMF when the user causes the wheel to rotate; the control system is configured to power off the electric vehicle controller and the electronic speed controller after a period of inactivity; the period of inactivity comprises a period of no rotation of the wheel; and/or the period of inactivity comprises a period of substantially no movement of the electric vehicle.

According to this disclosure, a user interface for an electric vehicle includes one or more of the following: optical transmitters in the electric vehicle capable of emitting light corresponding to operation information associated with the electric vehicle; and/or light pipes in the electric vehicle and corresponding to the optical transmitters, the light pipes configured to direct emitted light from the optical transmitters toward an exterior of the electric vehicle.

According to this disclosure, the user interface can further include one or more of the following: the optical transmitters comprise light emitting diodes; the light pipes are solid and translucent; the lights pipes taper in diameter from the optical transmitters to the exterior of the electric vehicle; the light pipes are arranged in a matrix pattern; and/or the operation information comprises at least one of remaining battery charge associated with a battery of the electric vehicle or a speed of travel of the electric vehicle.

According to this disclosure, a method for controlling an electric vehicle includes one or more of the following: monitoring for a user input indicative of a signal to accelerate, decelerate, or maintain a current velocity of the electric vehicle; detecting the user input; determining a speed or acceleration set point based on the detected user input; and/or adjusting the speed or acceleration of the electric vehicle based on the determined speed or acceleration set point.

According to this disclosure, the method may further include one or more of the following: said monitoring comprises measuring a back electromotive force (EMF) of an electric motor of the electric vehicle; said monitoring comprises measuring a rate of rotation of a wheel of the electric vehicle; said monitoring comprises analyzing an input from a sensor on the electric vehicle; the sensor comprises an accelerometer; the user input comprises a user pushing off the ground or a support surface with a foot or a stick to accelerate or decelerate the electric vehicle; the user input comprises a user dragging a foot or stick on the ground or the wheel of the electric vehicle to decelerate the electric vehicle; said determining a speed or acceleration set point is based on a frequency or number of user inputs detected; and/or the electric vehicle is an electric skateboard.

According to this disclosure, an electric skateboard includes one or more of the following: a deck; at least one battery on or within the deck; an electronic speed controller connected to the at least one battery; a motor connected to the electronic speed controller, wherein the electronic speed controller is configured regulate the speed of the motor; and/or an electric vehicle controller connected to the electronic speed controller. The deck can be accelerated by said electric vehicle controller sending an acceleration command to the electronic speed controller when said electric vehicle controller determines a user input corresponding to a user accelerating the skateboard. According to this disclosure, the electric skateboard can further include that the user input corresponds to a user moving the skateboard forward with respect to a direction of travel.

According to this disclosure, an electric skateboard includes one or more of the following: a deck and at least one battery, an electronic speed controller, an electric vehicle controller, and/or a motor. Said deck can be decelerated by said electric vehicle controller sending a deceleration command signal when said electric vehicle controller determines a user input corresponding to a user decelerating the skateboard, then communicating said braking command to said speed controller, which in turn controls said motor to contribute to the braking of said deck.

According to this disclosure, the electric skateboard can further include one or more of the following: the user input corresponding to a user decelerating the skateboard comprises the user dragging a foot or a stick on the ground or a support surface; said user input comprises a plurality of pushes, and wherein said electric vehicle controller determines a speed set point that is mathematically related to the number of said pushes; said user input comprises a plurality of pushes, and wherein said electric vehicle controller determines a speed set point for motor current and thus acceleration of said skateboard, said set point being mathematically related to the wheel speed surge characteristics during said pushes; said mathematical relationship is a proportionality to the average rate of change of said wheel speed during said pushes; said mathematical relationship is a proportionality to the frequency of said pushes; said mathematical relationship is a proportionality to both the average rate of change of said wheel speed during said pushes and the frequency of said pushes; and/or said user input is comprised of a plurality of braking actions, wherein said electric vehicle controller determines a set point for motor braking current and thus deceleration of said skateboard to a lower speed set point, said set point being mathematically related to a wheel speed of a wheel operable connected to said motor during said braking actions.

According to this disclosure, an electric skateboard includes one or more of the following: a deck and at least one battery, an electronic speed controller, an electric vehicle controller, and motor, optical transmitters, and/or light pipes. Said optical transmitters can be configured to communicate a status of at least one of said motor, electronic speed controller, or battery to an operator. Said optical transmitters can be mounted below the surface of said deck.

According to this disclosure, the electric skateboard can further include one or more of the following: the light pipes are configured to conduct transmissions corresponding to the status through a surface of said deck; said optical transmitters are light emitting diodes; said light pipes are conically tapered to a smaller diameter leading to the surface of the deck; and/or a plurality of said optical transmitters are arranged in a matrix format.

According to this disclosure, a method of casting light pipes into a skateboard deck, to form light pipes for the optical transmission of information to the board operator, includes one or more of the following: drilling a series of holes through the deck, pouring a curable liquid chemical over and in said holes, such that the liquid fills the holes, hardens and forms translucent light pipes, and/or machining said chemical flush with the deck surface once solidified. The method can further include that said liquid chemical can selected from the set containing two part clear epoxy and castable polyurethane.

According to this disclosure, an electric skateboard can include one or more of the following: a deck and at least one battery, electronic speed controller, electric vehicle controller, and/or a motor. Said electronic speed controller can be capable of being powered on by said electric vehicle controller sensing an action of a user pushing the deck and powered off automatically after a period of wheel inactivity. The method can further include that the electric skateboard does not have a power switch.

According to this disclosure, an electric skateboard can include one or more of the following: a deck and at least one battery, an electronic speed controller, an electric vehicle controller, motor, and/or at least one electromagnet interface coil. Said electric vehicle controller can be capable of pulsing said coil in a pulse train of variable frequency to simulate the function of a bicycle wheel permanent magnet or crank cadence permanent magnet. Said pulse train of variable frequency can be communicated to a cyclocomputer such that the cyclocomputer functions as a skateboard computer.

According to this disclosure, the electric skateboard can further include one or more of the following: the cyclocomputer is not customized for use with a skateboard; said cyclocomputer wheel speed is derived from the skateboard wheel speed by means of a divider algorithm in the electric vehicle controller; and/or said cyclocomputer pulse train is derived from the skateboard wheel speed by means of a peak velocity sensing algorithm in the electric vehicle controller, wherein the electric vehicle controller is capable of determining a stride rate at which the rider is pushing the board and is capable of converting the stride rate to a pushes per minute figure for output as a pulse train to the cadence coil.

The foregoing is a summary and contains simplifications, generalization, and omissions of detail. Those skilled in the art will appreciate that the summary is illustrative only and is not intended to be in any way limiting. Other aspects, features, and advantages of the devices and/or processes and/or other subject matter described herein will become apparent in the teachings set forth herein. The summary is provided to introduce a selection of concepts in a simplified form that are further described below in the Detailed Description. This summary is not intended to identify key features or essential features of any subject matter described herein.

### BRIEF DESCRIPTION OF THE DRAWINGS

The foregoing and other features of the present disclosure will become more fully apparent from the following description, taken in conjunction with the accompanying drawings. Understanding that these drawings depict only several embodiments in accordance with the disclosure and are not, therefore, to be considered limiting of its scope, the disclosure will be described with additional specificity and detail through use of the accompanying drawings.

FIG. 1 is a block diagram illustrating an electric vehicle including an embodiment of an electric vehicle interface with a control system.

FIG. 2 is a block diagram illustrating inputs into an electric vehicle controller of the control system of FIG. 1

FIG. 3 is a flow chart illustrating an embodiment of a method for controlling the velocity and/or acceleration of an electric vehicle.

FIG. 4A is a flow chart illustrating an embodiment of a method for powering on a control system for an electric vehicle.

FIG. 4B is a flow chart illustrating an embodiment of a method for powering off a control system for an electric vehicle.

FIG. 5 is a flow chart illustrating an example method that can be implemented by a control system for an electric vehicle.

FIG. 6A is a perspective detail view of an embodiment of a top side of a deck of an electric skateboard that includes a light pipe matrix display.

FIG. 6B is a detail perspective view of the light pipe matrix display of FIG. 6A.

FIG. 7 is a perspective view of a bottom side of the deck of FIG. 6A that includes the light pipe matrix display.

FIG. 8A is a longitudinal cross-sectional perspective view of the deck of FIG. 6A.

FIG. 8B is a detail view of a longitudinal cross-section of the light pipe matrix display.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description and the drawings are not meant to be limiting. Other embodiments may be utilized, and other changes may be made, without departing from the spirit or scope of the subject matter presented herein. It will be readily understood that the aspects of the present disclosure, as generally described herein, and illustrated in the figures, may be arranged, substituted, combined, and designed in a wide variety of different configurations, all of which are explicitly contemplated and made a part of this disclosure.

In some embodiments described herein, an electric vehicle interface and/or electric vehicle control system allows a user (e.g., a rider, operator, etc.) to interact with (e.g., control, input or view information, etc.) an electric vehicle. In many of the examples described herein, the electric vehicle is an electric or motorized skateboard, although this disclosure is not intended to be limited only thereto. The electric vehicle interfaces and/or electric vehicle control systems described herein are useable with many types of electric vehicles. In some embodiments, the electric vehicle interface and/or electric vehicle control system described herein can be used in, for example, electric skateboards, motorized surfboards, roller skates, inline skates, grass skis, electric scooters, street luge boards, last leg vehicles, bicycles, recreational vehicles, wheel chairs, electric warehouse and factory cars, buggies, slot cars, dodgem cars, trolleys, tracked vehicles and trams, etc.

Existing electric skateboards (or other electric vehicles) typically use a handheld remote control or require the user to shift his or her weight or position their feet on pressure sensors or pedals to interface with (i.e., control) the electric skateboard. Use of a remote can be inconvenient. Using the remote control to operate the electric skateboard, for example, limits the use of one hand, thus prohibiting hands free operation of the electric skateboard. Handheld remotes are typically held in a user's hand to operate the control functions of the remote. Often, these remotes can easily be dropped while riding. Additionally, remotes have to be found and charged before the electric skateboard can be used. In some instances, a user may lose the remote, as it is easily separable from the electric skateboard. Further, handheld remotes can be tiring to use. It is necessary with most remotes to hold the thumb in a precise and fixed position in order to keep the electric skateboard moving at the desired speed. It may be uncomfortable to do this for extended periods of time. Most electric skateboards do not have a cruise control. Use of pressure sensors or pedals to control the electric skateboard can also be inconvenient. Pressure sensors or pedals are often mounted in the deck of the electric skateboard and require the user to assume an unnatural or limited riding position to operate the controls.

Further, existing electric skateboards generally include some method to display to the user the remaining operating range, for example, as a fuel/power gauge that displays remaining battery capacity or simply by an indication of battery voltage. In many instances, this display is incorporated into the remote by means of light emitting diodes (LED indicators), or on the deck by means of a single color changing LED.

In some instances, a mobile phone (or other similar device) is used as the remote control for existing electric skateboards. For example, an electric skateboard can include a Bluetooth interface to a mobile phone running an application to view information about and/or control the electric skateboard. This can be inconvenient because the user must get out, hold, unlock the phone, change to the relevant application, and the correct page thereof, to view the remaining range or control the electric skateboard all while riding. This can be both inconvenient and unsafe.

In addition, existing electric skateboards typically have a power switch. This is inconvenient since it requires the user to bend down and turn the electric skateboard on before it can be used. After use, the user must switch the board off, to avoid flattening the battery. If a user forgets to power off the electric skateboard, the battery will drain and require recharging before the electric skateboard can be used again.

Finally, existing electric skateboards are often readily identified as electric or motorized skateboards by the presence of the remote control, the LED on the deck, the power switch, and/or a battery box.

Some of the embodiments of the electric vehicle interfaces and/or control systems disclosed herein can alleviate or eliminate one or more of these disadvantages of existing electric skateboard and/or can provide one or more of the following advantages: mitigating or substantially eliminating the need for a handheld remote; mitigating or substantially eliminating the need for a power switch; allowing the user to control the electric vehicle (such as an electric skateboard) with natural riding actions that are supplemented by the motor to assist in, for example, accelerating and braking; providing an improved status display to the user; and/or having minimal or substantially no external giveaways indicating that the vehicle is electric or motorized, among others.

Some embodiments disclosed herein mitigate or substantially eliminate the need to hold a remote and do not require foot switches on the vehicle (e.g., on the deck of an electric skateboard) or an application on a mobile phone. As described above, the electric vehicle interface and/or control system allows the user to interact with the electric vehicle (for example, to control accelerating and braking) in a similar manner as with an unpowered vehicle, thus making the interface natural and easy to learn. For example with an electric skateboard, the operator pushes the board to accelerate, and drags a foot to brake, the same as on an unpowered skateboard. The foot may be dragged either on a tire or on the road. Voltage or speed of the motor can be detected and monitored, and used by the electric vehicle controller to determine what speed, acceleration, or deceleration is desired. Alternatively or in addition to the foot, in the case of an electric skateboard, a stick may be used to push the electric skateboard, both to accelerate and brake.

In some embodiments according to the disclosure herein, the disclosed electric vehicle interface and/or control system substantially eliminates or mitigates the need for the user to carry a remote control, step on deck mounted pedals, and/or shift the user's weight on the board to control the acceleration and deceleration of the electric vehicle. In some embodiments, the electric vehicle interface and/or control system is responsive to user inputs. The control system of the electric vehicle may include the electric vehicle interface. In some embodiments, the user inputs are user actions that are commonly used when operating a similar non-electric vehicle. For example, a user commonly pushes off the ground with a foot or stick to accelerate a non-electric (non-motorized) skateboard, and drags a foot or stick on the ground or a wheel to decelerate the non-electric skateboard. In some embodiments, the control system is responsive to these same types of “natural” user inputs to control the operation of the electric vehicle. For example, in some embodiments, the user inputs include pushing off the ground with a foot or stick to accelerate and/or dragging a foot or stick on the ground or a wheel of the electric vehicle to decelerate or brake, among other types of user inputs.

In some embodiments, the user inputs are detected by an electric vehicle controller of the control system of the electric vehicle interface. When user inputs are detected, the electric vehicle controller can send signals to an electronic speed controller (ESC), which controls an electric motor that is operably connected to a wheel of the electric vehicle, to supplement the user's actions. For example, in the case of an electric skateboard, a user may push off the ground to accelerate. This action can be detected by the electric vehicle controller as a user input that indicates that the user desires to increase the velocity of the electric skateboard. The electric vehicle controller can then send a signal to the electronic speed controller to increase velocity. The electronic speed controller may then send a signal to the electric motor that will cause the electric motor to increase velocity.

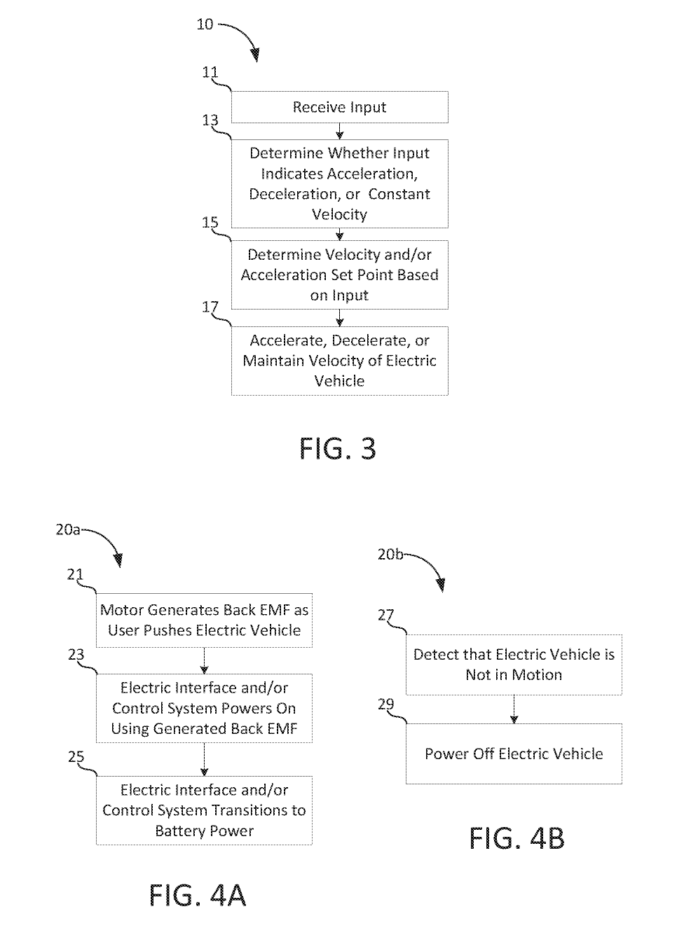

In some embodiments, the electric vehicle controller may detect user inputs, and, based on the user inputs, set a speed or acceleration set point in order to initiate an acceleration (e.g., set an acceleration rate or set point), initiate a deceleration (e.g., set a deceleration rate or set point), or maintain a constant velocity, as shown for example in method 10 of FIG. 3.

In some embodiments, the electronic components of the electric vehicle can be configured to automatically turn on and off, such that the electric vehicle does not require a power switch. For example, the back electromotive force (“back EMF”) generated by the electric motor when a user pushes the board causing the wheels to rotate can be used to power on the electronic components (for example, the electric vehicle controller, the electronic speed controller, and others) of the electric vehicle, for example, as shown in method 20a of FIG. 4A. In some embodiments, the electric vehicle controller monitors the motion of the electric vehicle and powers off, shuts down, or otherwise idles (e.g., reduced power consumption state) the electronic components after a period of inactivity, for example, as shown in method 20b of FIG. 4B.

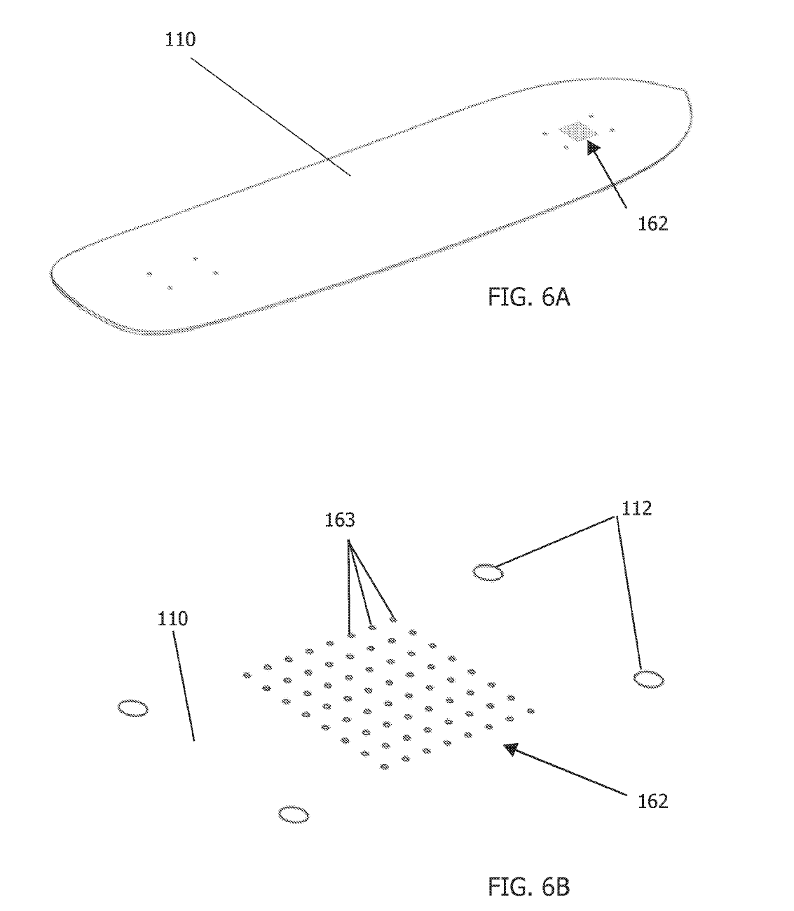

In some embodiments, the electric vehicle interface can include a display. The display can be configured to display information about the electric vehicle to the user. The display can be positioned on the electric vehicle. For example, in the case of an electric skateboard, the display can be positioned on (or built into) a deck of the skateboard. In some embodiments, the user interface can include a hidden light pipe matrix display that uses light pipes to a pinhole array, as shown, for example, in FIGS. 6A-8B.

In some embodiments, the electric vehicle interface can include a connection to a portable computer or computing device (e.g., a bicycle cyclocomputer, mobile phone, tablet computer, etc.). The connection can be configured to connect to one or more commercially available portable computers, mitigating the need for the development of a custom computer suited for the particular electric vehicle. This can, for example, allow a commercially available bicycle cyclocomputer to be used with an electric skateboard. In some embodiments, the electric vehicle interface can be configured to interface with an application that is downloaded onto, for example, a mobile phone. The application can connect to the electric vehicle (for example, to the electric vehicle controller) via any suitable wireless protocol, including Bluetooth, Wi-Fi, etc. In some embodiments, a wired connection may be used.

In some embodiments, the electric vehicle interface is not substantially visible or apparent when the electric vehicle is in use. For example, in the case of an electric skateboard, the electric vehicle interface is not substantially visible or apparent such that the electric skateboard generally appears to be a conventional (i.e., non-motorized or non-electric) skateboard.

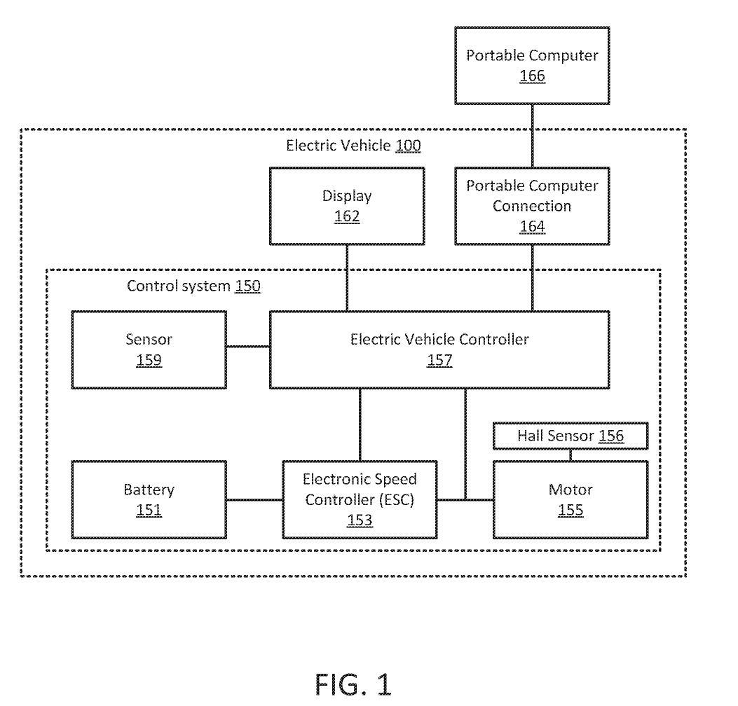

FIG. 1 is a block diagram illustrating an electric vehicle 100 including an embodiment of an electric vehicle interface with a control system 150. In some embodiments, the electric vehicle 100 is an electric skateboard, although other types of electric vehicles are possible. The electric vehicle 100 includes an electric vehicle interface that allows a user to interact with the electric vehicle 100. For example, the electric vehicle interface includes a display 162. The display 162 is configured to display information (e.g., operation information) about the electric vehicle 100 to the user. In some embodiments, the display 162 can display information about battery life/power/charge, range, motor voltage, current, or frequency, speed, distance, time, etc. In some embodiments, the display 162 comprises a light pipe matrix, for example, as shown in FIGS. 6A-8B and discussed below. In some embodiments, the display 162 can be omitted.

The electric vehicle interface also includes a control system 150. The control system 150 can be configured to detect user inputs and control the velocity and/or acceleration of the electric vehicle 100 based upon the detected user inputs. As discussed above, in some embodiments, the user inputs are user actions that are commonly used when operating a similar non-electric vehicle. For example, in some embodiments, the user inputs include pushing off the ground with a foot or stick to signal a desire to accelerate and/or dragging a foot or stick on the ground or a wheel of the electric vehicle 100 to signal a desire to decelerate or brake. These same actions are commonly performed when operating a non-electric or non-motorized skateboard. In some embodiments, the control system 150 detects these user inputs and automatically adjusts the speed and/or acceleration of the electric vehicle 100 accordingly. For example, in the case of an electric skateboard, a user may push off the ground to accelerate. This action can be detected by the control system 150 as a user input that indicates that the user desires to increase the velocity. The control system 150 can then increase the velocity of the electric skateboard.

As illustrated in FIG. 1, the control system 150 includes a battery 151, an electronic speed controller (ESC) 153, a motor 155, an electric vehicle controller 157, and a sensor 159. In the case of an electric skateboard, one or more of these components can be mounted in, on, or under a deck of the electric skateboard. In some embodiments, the motor 155 is mounted within a motorized wheel of the electric skateboard, for example, as described in Patent Cooperation Treaty (PCT) Application Nos. PCT/IB2016/000536, filed Apr. 8, 2016, and PCT/US2016/056919, filed Oct. 13, 2016, each of which is incorporated by reference herein.

The battery 151 is connected to the electronic speed controller 153, and the electronic speed controller 153 is connected to the motor 155. The motor 155 is operably connected to a wheel of the electric vehicle 100 to drive the wheel to propel the electric vehicle 100. The motor 155 can be an electric motor. In some embodiments, the motor 155 is an AC motor. In some embodiments, the motor 155 is a DC motor. The electronic speed controller 153 is configured to regulate the speed of electric motor 155, by, for example, adjusting an operating voltage, current, or frequency of the motor 155. Power is supplied by the battery 151. The battery 151 may also power additional electronic components of the electric vehicle 100 (such as the electric vehicle controller 157 and/or display 162).

The electronic speed controller 153 is connected to an electric vehicle controller 157. The electric vehicle controller 157 provides instructions to the electronic speed controller 153 regarding how to regulate the speed of the motor 155. The electric vehicle controller 157 is also configured to detect user inputs, and the electric vehicle controller 157 generates the instructions for the electronic speed controller 153 based on the detected user inputs. In the illustrated embodiment, the electric vehicle controller 157 is connected to the motor 155 so as to receive information (e.g., the operating speed, voltage, current, frequency, etc.) about the operation of the motor 155. As will be described below, in some embodiments, the electric vehicle controller 157 interprets this information about the operation of the motor to detect user inputs. The electric vehicle controller 157 is also connected to a sensor 159. The sensor 159 can be an accelerometer, gyroscope, or other type of sensor for measuring motion. As will be discussed below, in some embodiments, the electric vehicle controller 157 detects the user inputs based on information received from the sensor 159. Thus, in some embodiments, the need for a remote control can be mitigated or substantially eliminated by the use of the electric vehicle controller 157, which regulates the speed of the electric vehicle 100 based on user inputs generated by the user.

In some embodiments, the electric vehicle controller 157 monitors (e.g., measures, detects, senses, or otherwise receives information about) the operation of the motor 155 to detect the user inputs. For example, the electric vehicle controller 157 can be connected to the motor 155 to monitor the back EMF of the motor 155. The motor 155 may generate back EMF when the rotor of the motor 155 rotates. In some embodiments, when the wheel causes the motor 155 to rotate faster or slower than the electronic speed controller 153 specifies, the amount of back EMF can vary. The electric vehicle controller 157 can detect these variations in back EMF and use them to determine user inputs.

For example, if/when the electronic speed controller 153 is controlling the motor 155 to cause the wheel to rotate at a specified velocity and the user begins to push off the ground with his or her foot, the user's action may cause the wheel (and correspondingly the motor 155) to rotate faster than the specified velocity. This can cause the motor 155 to generate back EMF, which can be detected by the electric vehicle controller 157. The electric vehicle controller 157 can determine from the back EMF that the user is pushing off the ground and send a signal to the electronic speed controller 153 to increase the speed of the motor 155.

Similarly, when a user drags his or her foot on the ground, the wheel may rotate at a velocity less than the velocity specified by the electronic speed controller 153. Again, this creates back EMF, which is detected by the electric vehicle controller 157. From the back EMF, the electric vehicle controller 157 can determine that the user is providing a user input that indicates a desire to slow down and can then provide a signal to the electronic speed controller 153 to decrease the speed of the motor 155.

In some embodiments, the electric vehicle controller 157 monitors for changes in wheel speed of the electric vehicle 100. In some embodiments, wheel speed is determined by the electric vehicle controller 157 based on the frequency or voltage of the back EMF generated by the change in velocity of the wheel caused by a user input. In some embodiments, back EMF is used to determine wheel speed when the electronic speed controller 153 is off (e.g., not driving the wheel) and the phase current of the frequency of the motor 155 is used to determine wheel speed when the electronic speed controller 153 is on (e.g., driving the wheel). Other methods for determining wheel speed are also possible.

In some embodiments, the motor 155 includes one or more hall sensors 156, such as optical or hall sensor(s) (e.g., Hall Effect sensor(s)). For example, a hall sensor 156 operates with one or more magnets mounted on a rotor and/or a stator of the motor 155 to detect or count ticks by, for example, detecting an induced voltage or current change when the one or more magnets pass the hall sensor 156 as the rotor and the stator rotate relative to each other. In some embodiments, the hall sensors 156 may be mounted on the electric vehicle wheel and the axle of the wheel. The sensor pulse train generated by the one or more hall sensors 156 can be used by the electric vehicle controller 157 as the frequency source for determining wheel speed. The determined wheel speed characteristics can then be used by the electric vehicle controller 157 to determine user inputs. The determined wheel speed characteristics can include changes of wheel speed, rate of change of wheel speed, frequency of changes of wheel speed, etc.

In some embodiments, a high or relatively higher frequency of the back EMF and/or signal from the hall sensor 156 can indicate that a user is accelerating the electric vehicle 100 in a manner indicating desired acceleration, such as by providing a user input of kicking or pushing against the ground to accelerate. A low or relatively lower frequency of the back EMF and/or signal from the hall sensor 156 may indicate that a user is pushing the electric vehicle 100 in a manner indicating a desired speed or indicating that a certain speed of the electric vehicle 100 is desired.

In some embodiments, the sensor 159 provides information to the electric vehicle controller 157 from which the user inputs can be determined. For example, the sensor 159 can be an accelerometer, gyroscope, or other sensor for measuring motion. The sensor 159 can detect when the user is providing a user input that is causing the electric vehicle 100 to accelerate (e.g., pressing off the ground, etc.). Based on this user input, the electric vehicle controller 157 can send a signal to the electronic speed controller 153 to cause acceleration. Similarly, the sensor 159 can detect when the user is providing a user input that causes the electric vehicle 100 to decelerate (e.g., dragging a foot on the ground or wheel, etc.). Based on this user input, the electric vehicle controller 157 can send a signal to the electronic speed controller 153 to cause deceleration.

In some embodiments, the electric vehicle controller 157 may detect user inputs based on operating characteristics of the motor 155 (e.g., back EMF, wheel speed, etc.) and information received from the sensor 159. In some embodiments, only or solely the operating characteristics of the motor 155 or information received from the sensor 159 may be used. The user inputs imparted by the user onto the electric vehicle 100 and detected by the electric vehicle controller 157 can be indicative of desired input, action, or operation (e.g., accelerate, decelerate, or maintain speed) for the electric vehicle 100. User inputs can be directly detected (e.g., via sensor 159) and/or indirectly detected through changes (or lack thereof) in, for example, the speed/voltage of the motor 155 or other components of the electric vehicle 100.

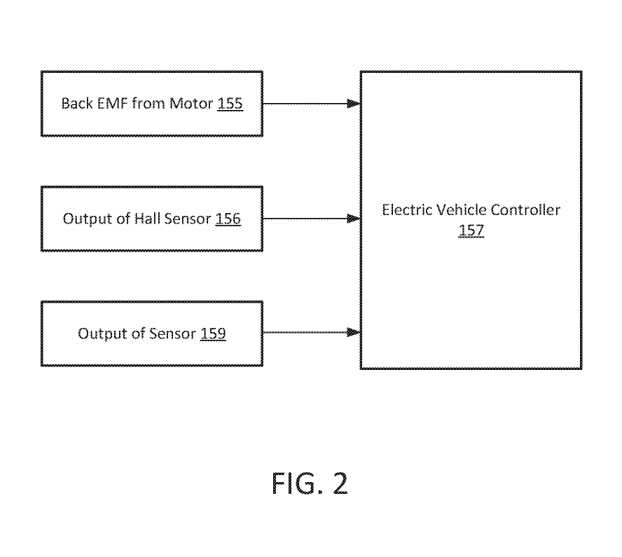

FIG. 2 is a block diagram which illustrates various input signals to the electric vehicle controller 157 according to one embodiment. The electric vehicle controller 157 can use the input signals to determine user inputs that are used to control the electric vehicle 100. In the illustrated embodiment, the electric vehicle controller 157 receives as input signals the back EMF from the motor 155, the output of the hall sensor 156, and/or the output of the sensor 159. In some embodiments, the electric vehicle controller 157 can receive greater or fewer numbers of input signals than are illustrated in FIG. 2. When/if multiple input signals are received by the electric vehicle controller 157, one or more of the input signals can be used to determine the user inputs. For example, in some embodiments, two or more input signals can be averaged together. As another example, one input signal can be checked against another input signal to verify a user input. For example, the electric vehicle controller 157 can determine a user input to accelerate from the back EMF. Before accelerating the electric vehicle 100, the electric vehicle controller 157 can verify the user input signal by separately analyzing the input signal from the sensor 159. When/if the input signal from the sensor 159 also indicates a user input to accelerate, the electric vehicle controller 157 can accelerate the electric vehicle 100.

In some embodiments, the electric vehicle controller 157 detects a plurality of user inputs and uses the plurality of user inputs to determine how to adjust the speed of the electric vehicle 100. For example, the electric vehicle controller 157 can be configured to detect a number of pushes provided by the user or a rate (or frequency) of pushes provided by the user. In some embodiments, the electric vehicle controller 157 can be configured to increase the speed of the electric vehicle 100 in proportion to the number of pushes provided by the user. In other words, the more a user pushes, the faster the electric vehicle 100 will go. As another, example, the electric vehicle controller 157 can be configured to increase the speed of the electric vehicle 100 in proportion to the rate of pushes provided by the user. For example, the faster the user provides the pushes (i.e., the shorter the time period between consecutive pushes), the faster the electric vehicle 100 will go. In some embodiments, other mathematical relationships, beyond proportionality, can be used.

In some embodiments, the electric vehicle controller 157 is configured to detect a length (i.e., duration) of a user input and use the length of the user input to determine how to adjust the speed of the electric vehicle 100. For example, the electric vehicle controller 157 can detect how long a user drags his or her foot and adjust the speed of the electric vehicle 100 accordingly. For example, the electric vehicle controller 157 can decrease speed proportionally to the length of time a user drags his or her foot. That is, the longer a user drags his or her foot, the more the electric vehicle 100 will decelerate. In some embodiments, other mathematical relationships, beyond proportionality, can be used.

The electric vehicle controller 157 provides signals to the electronic speed controller 153 to regulate control of the motor 155. In some embodiments, the signals include a speed set point (e.g., a target or desired speed) and/or an acceleration or deceleration set point (e.g., a target or desired acceleration).

In some embodiments, because the electric vehicle controller 157 is connected to the motor 155, the back EMF of the motor 155 can be used to power up the electronic components of the electric vehicle 100 (such as the electric vehicle controller 157 and electronic speed controllers 153, among others), bootstrapping the power supply until the electronic components can switch themselves on to the battery 151. Battery drain from the electric vehicle controller 157 having to wake periodically to check the back EMF can be substantially eliminated or mitigated by using the generated back EMF as an auxiliary power source for the electronic components.

For example, when a user pushes off the ground to accelerate the electric vehicle 100 from rest the motor 155 generates back EMF. This back EMF can be used to power on the electric vehicle controller 157, the electronic speed controller 153, and/or sensor 159. Additionally, after the wheels stop turning for a period of time, the electric vehicle controller 157 can automatically power off the electronic speed controller 153, any other electronic components, and itself. Because the electronic components can automatically power on and off in response to motion or lack of motion of the electric vehicle 100, a power switch need not be included on the electric vehicle 100 (e.g., the electric vehicle 100 does not have a power switch).

Several embodiments of example methods that can be implemented by the electric vehicle controller 157 are shown in FIGS. 3-5 and will be described below. In some embodiments, a single controller comprises the electric vehicle controller 157 and the electronic speed controller 153, such that the single controller is configured to control the motor 155 and is further configured to monitor the operating characteristic of the motor 155 and determine the user inputs.

As shown in FIG. 1, the electric vehicle controller 157 is connected to the display 162. The electric vehicle controller 157 can determine the information that is displayed on the display 162. The electric vehicle controller 157 is also connected to a portable computer connection 164. The portable computer connection 164 can be configured to connect to a portable computer 166 to display additional information about the electric vehicle 100. The connection 164 can send and/or transmit an information signal to the portable computer 166 corresponding to operation information of electric vehicle 100. The connection 164 can also receive and/or sense signals from the portable computer 166 corresponding to, for example, commands from the user.

The portable computer 166 can be, for example, a bicycle cyclocomputer, a mobile phone, a tablet computer, etc. The connection 164 can be configured to connect to one or more commercially available portable computers 166, mitigating the need for the development of a custom computer suited for the particular electric vehicle 100. This can, for example, allow a commercially available bicycle cyclocomputer to be used with an electric skateboard. In some embodiments, the portable computer connection 164 includes at least one electromagnet interface coil. The electric vehicle controller 157 can be configured to pulse the coil in a pulse train of variable frequency, to simulate the function of a bicycle wheel permanent magnet or crank cadence permanent magnet. This can render a conventional cyclocomputer functional as a skateboard computer, without needing the cyclocomputer to be customized to suit a skateboard.

FIG. 3 is a flow chart illustrating an embodiment of a method 10 for controlling the velocity and/or acceleration of an electric vehicle 100. The method 10 can be implemented by the electric vehicle controller 157 of the control system 150 described above. In some embodiments, the electric vehicle 100 can be an electric skateboard. The method 10 includes a step 11 for receiving a user input; a step 13 for determining whether the input indicates acceleration, deceleration, or constant velocity; a step 15 for determining velocity and/or acceleration set points based on the input; and a step 17 for accelerating, decelerating, and/or maintaining the velocity of the electric vehicle 100.

As discussed above, in some embodiments, the user inputs are user actions that are commonly used when operating a similar non-electric vehicle. For example, a user commonly pushes off the ground with a foot or stick to accelerate a non-electric (non-motorized) skateboard, and drags a foot or stick on the ground or a wheel to decelerate the non-electric skateboard. In some embodiments, the control system 150 is responsive to these same types of natural user inputs to control the operation of the electric vehicle 100. Thus, in some embodiments, the user inputs include pushing off the ground with a foot or stick to accelerate and/or dragging a foot or stick on the ground or a wheel of the electric vehicle 100 to decelerate or brake, among other types of user inputs.

In some embodiments of the method 10, the step 11 for receiving an input includes detecting a user input with the electric vehicle controller 157 based on the input signals received from the motor 155, the hall sensor 156, and/or the sensor 159 (see FIG. 2). For example, the electric vehicle controller 157 can detect a change in the voltage, current, and/or frequency of the back EMF of the motor 155 and determine a user input from this change. Similarly, the electric vehicle controller 157 can determine a user input based on a change in wheel speed as determined based on back EMF, the output of the hall sensor 156, or any other method. In some embodiments, the user input is determined based on the output of the sensor 159. For example, the output of the sensor 159 may indicate an acceleration of the electric vehicle 100 caused by the user pushing off the ground. The electric vehicle controller 157 can determine the user input from this acceleration data.

In some embodiments, step 13 for determining whether the input indicates acceleration, deceleration, or constant velocity can include analyzing the input. For example, if/when the user input causes an increase in the voltage, current, or frequency of back EMF, wheel speed, or acceleration, the input may be determined to represent acceleration. As another example, if/when the user input causes a decrease in the voltage, current, or frequency back EMF, wheel speed, or acceleration, the input may be determined to represent deceleration.

In some embodiments, step 15 for determining a velocity and/or acceleration set point based on the input can be based on further analysis of the input. For example, in some embodiments, the electric vehicle controller 157 detects a plurality of user inputs and uses the plurality of user inputs to determine how to adjust the speed of the electric vehicle 100. The electric vehicle controller 157 can be configured to detect a number of pushes provided by the user or a rate (or frequency) of pushes provided by the user. In some embodiments, the electric vehicle controller 157 can be configured to increase the speed of the electric vehicle 100 in proportion to the number of pushes provided by the user. In other words, the more a user pushes, the faster the electric vehicle 100 will go. As another, example, the electric vehicle controller 157 can be configured to increase the speed of the electric vehicle 100 in proportion to the rate of pushes provided by the user. For example, the faster the user provides the pushes (i.e., the shorter the time period between consecutive pushes), the faster the electric vehicle 100 will go. In some embodiments, other mathematical relationships, beyond proportionality, can be used.

As another example, the electric vehicle controller 157 can be configured to detect a length (i.e., duration) of a user input and use the length of the user input to determine how to adjust the speed of the electric vehicle 100. For example, the electric vehicle controller 157 can detect how long a user drags his or her foot and adjust the speed of the electric vehicle 100 accordingly. For example, the electric vehicle controller 157 can decrease speed proportionally to the length of time a user drags his or her foot. That is, the longer a user drags his or her foot, the more the electric vehicle 100 will decelerate. In some embodiments, other mathematical relationships, beyond proportionality, can be used.

At step 15, if/when the user input indicates a desire to accelerate, the electric vehicle controller 157 determines a higher velocity set point or a positive acceleration set point. As another example, if/when the user input indicates a desire to decelerate, the electric vehicle controller 157 determines a lower velocity set point or a negative acceleration set point. In some embodiments, the velocity or acceleration set point is related to the nature of the user input. For example, if/when the user input comprises a series of pushes or braking actions, the velocity or acceleration set point may be proportional to the number or rate of the pushes or braking actions. As another example, the velocity or acceleration set point can be set in proportion to a length or duration of a user input (for example, a length of time a user drags his or her foot). In some embodiments, other relationships, beyond proportionality, can be used.

In some embodiments, step 17 for accelerating, decelerating, or maintaining the velocity of the electric vehicle 100 can include transmitting instructions to the electronic speed controller 153.

FIG. 4A is a flow chart illustrating an embodiment of a method 20a for powering on the control system 150 for an electric vehicle 100. The method 20a includes a step 21 at which the motor 155 generates back EMF as a user moves (e.g., pushes) the electric vehicle 100 to start if from rest; a step 23 at which the electric interface and/or control system 150 powers on using the generated back EMF; and a step 25 at which the electric interface and/or control system 150 transitions to battery power.

FIG. 4B is a flow chart illustrating an embodiment of a method 20b for powering off the control system 150 for an electric vehicle 100. The method 20b includes a step 27 for detecting that the electric vehicle 100 is not in motion, and a step 29 for powering off the electric vehicle 100.

In some embodiments, step 27 for detecting that the electric vehicle 100 is not in motion can include determining that a wheel of the electric vehicle 100 is not rotating. In some embodiments, the back EMF and/or the output of the hall sensor 156 are used to determine whether the wheel is rotating. In some embodiments, step 27 for detecting that the electric vehicle 100 is not in motion can include analyzing the output signal from the sensor 159 to determine that the electric vehicle 100 is not in motion. For example, when sensor 159 is an accelerometer, motion sensor, or gyroscope, the output signal from the sensor 159 can be analyzed to determine whether the electric vehicle 100 is in motion. In some embodiments, step 27 of the method 20b is performed for a predetermined time period before proceeding to step 29. For example, the method 20b can wait for a predetermined duration of inactivity before proceeding to step 29. In some embodiments, the predetermined period of time is about 3 seconds, about 5 seconds, about 10 seconds, about 15 seconds, about 30 seconds, or about 1 minute, although longer and shorter times, or times between the listed values, can also be used.

In some embodiments, step 29 for powering off the electric vehicle 100 can include powering off, shutting down, or otherwise transitioning to an idle state (e.g., reduced power consumption state) the electronic components of the electric vehicle 100. This can include, for example, powering off, shutting down, or otherwise transitioning to an idle state the control system 150, including the electric vehicle controller 157, electronic speed controller 153, sensor 159, etc., as well as the display 162, and any other electronic components.

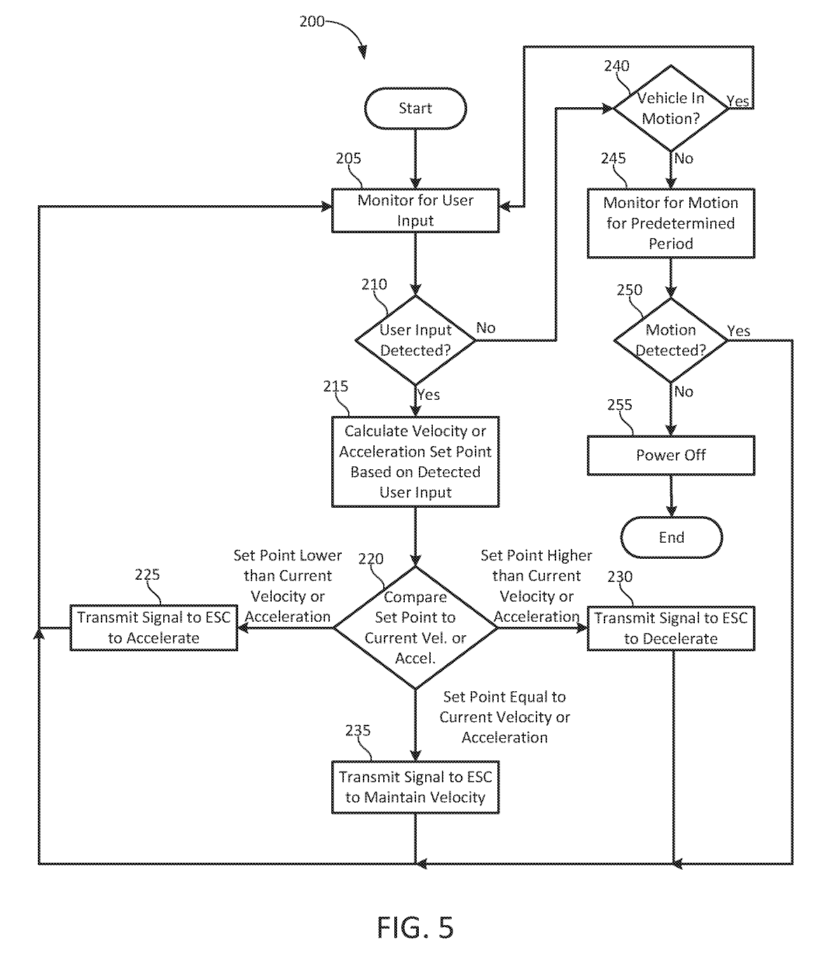

FIG. 5 is a flow chart illustrating an example method 200 that can be implemented by the electric vehicle controller 157. Although illustrated in a particular order, the blocks of the method 200 can be rearranged. In some embodiments, one or more of the blocks of the method 200 can be omitted. The method 200 can include additional blocks or steps.

The method 200 proceeds from a start block to block 205, at which the electric vehicle controller 157 monitors for a user input. The user input can include a user action that indicates a change in velocity (i.e., a desire to accelerate or decelerate) or that the current velocity should be maintained. For example, the user input can be a user pushing off the ground or dragging a foot on the ground or wheel, as described above. As noted above, the electric vehicle controller 157 can monitor the operating characteristics of the motor 155 and/or the sensor 159 for a user input. The method 200 next moves to decision state 210, at which it determines whether a user input is detected. If/when a user input 210 is detected, the method 200 moves to block 215.

At block 215, the electric vehicle controller 157 calculates a velocity or acceleration set point based on the detected user input. For example, if/when the user input indicates a desire to accelerate, the electric vehicle controller 157 determines a higher velocity set point or a positive acceleration set point. As another example, if/when the user input indicates a desire to decelerate, the electric vehicle controller 157 determines a lower velocity set point or a negative acceleration set point. In some embodiments, the velocity or acceleration set point is related to the nature of the user input. For example, if/when the user input comprises a series of pushes or braking actions, the velocity or acceleration set point may be proportional to the number or rate of the pushes or braking actions. As another example, the velocity or acceleration set point can be set in proportion to a length or duration of a user input (for example, a length of time a user drags his or her foot). In some embodiments, other relationships, beyond proportionality, can be used.

The method then moves to decision state 220, at which the calculated set point is compared to the current velocity or acceleration of the electric vehicle 100. If/when the calculated set point is lower than the current velocity or acceleration, the method 200 moves to block 225, at which the electric vehicle controller 157 transmits a signal to the electronic speed controller 153 to accelerate to the calculated set point. If/when the calculated set point is equal to the current velocity or acceleration, the method 200 moves to block 235, at which the electric vehicle controller 157 transmits a signal to the electronic speed controller 153 to maintain the current velocity or acceleration. If/when the calculated set point is higher than the current velocity or acceleration, the method 200 moves to block 230, at which the electric vehicle controller 157 transmits a signal to the electronic speed controller 153 to decelerate to the calculated set point. From each of blocks 225, 230, 235, the method moves back to block 205, at which the electric vehicle controller 157 monitors for further user input.

If/when, at decision state 210, a user input is not detected, the method moves to decision state 240, which determines whether the electric vehicle 100 is in motion. In some embodiments, this is determined by the electric vehicle controller 157 checking whether one or more of the wheels of the electric vehicle 100 is spinning. In some embodiments, this is determined by the sensor 159. If, at decision state 240, the vehicle is determined to be in motion, the method moves back to block 205, at which the electric vehicle controller 157 monitors for user input. If/when the vehicle is determined not to be in motion at decision state 240, the method 200 moves to block 245.

At block 245, the electric vehicle controller 157 monitors for motion of the electric vehicle 100 for a predetermined period of time. In some embodiments, the predetermined period of time is about 3 seconds, about 5 seconds, about 10 seconds, about 15 seconds, about 30 seconds, or about 1 minute, although longer and shorter times, or times between the listed values, can also be used. At decision state 250, if/when motion is detected during the predetermined period of time, the method 200 moves back to block 205 to monitor for further user input. If/when motion is not detected, the method 200 moves from decision state 250 to block 255, at which the electric vehicle controller 157 powers off the electronic components (including itself) of the electric vehicle 100. From block 255, the method 200 moves to an end block.

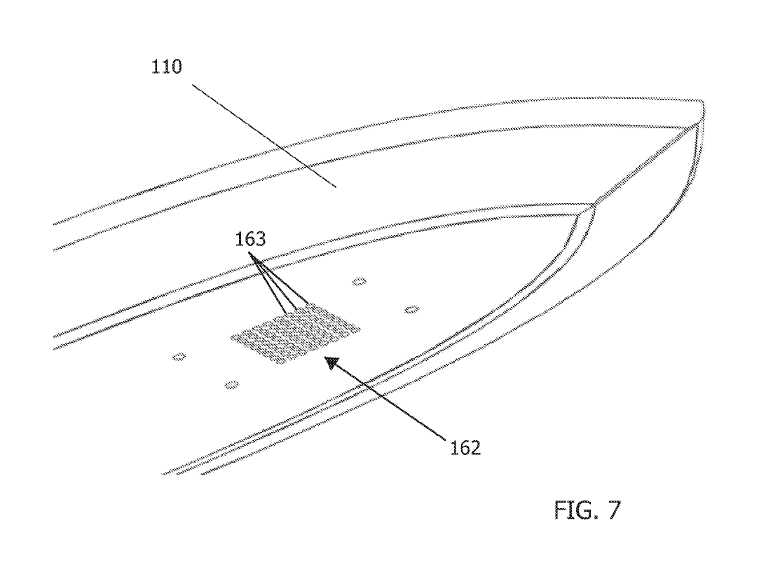

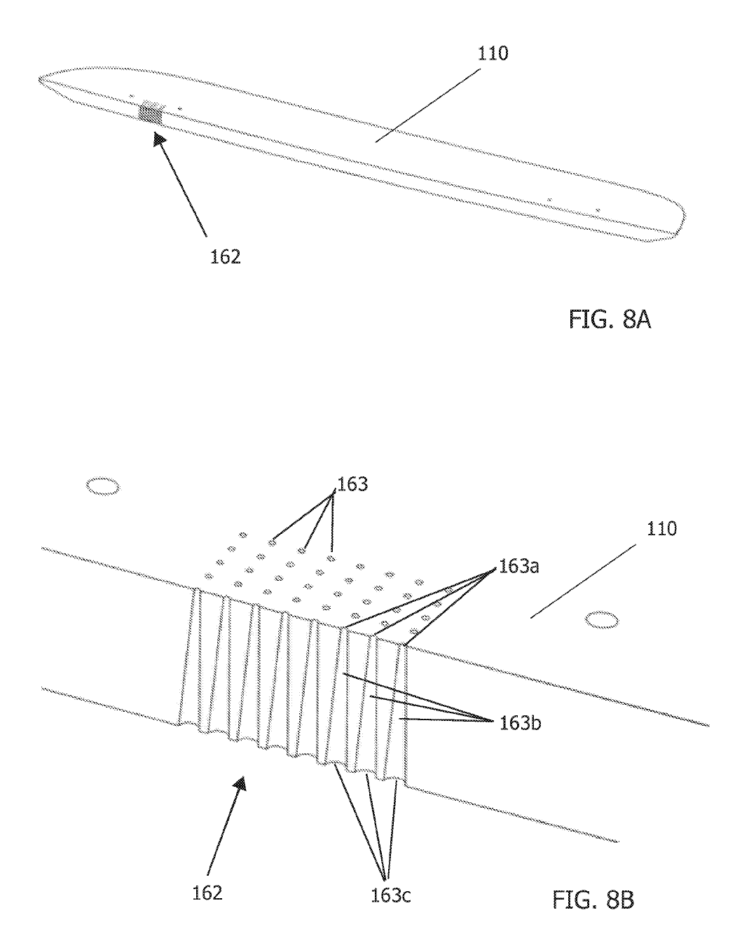

As illustrated in the block diagram of FIG. 1, the electric vehicle interface for the electric vehicle 100 includes a display 162. FIGS. 6A-8B illustrate views of an embodiment of a deck 110 of an electric skateboard that includes a display 162, which is configured as a light pipe matrix. FIG. 6A is a perspective detail view of an embodiment of a top side of the deck 110 of an electric skateboard that includes a light pipe matrix display 162. FIG. 6B is a detail perspective view of the light pipe matrix display 162 of FIG. 6A. FIG. 7 is a perspective view of a bottom side of the deck 110. FIG. 8A is a longitudinal cross-sectional perspective view of the deck 110. FIG. 8B is detail view of a longitudinal cross-section of the light pipe matrix display 162.

In the illustrated embodiment of FIG. 6A, the light pipe matrix display 162 is positioned at a front portion of the deck 110, approximately above the location where the truck attaches to the deck 110. This location may be structurally advantageous because at this location the deck 110 is subjected to limited flexure and the light pipe matrix display 162 is protected by other components of the electric skateboard, such as the truck. FIG. 6B illustrates the light pipe matrix display 162 in greater detail. As shown, the light pipe matrix display 162 is positioned substantially between bolt holes 112 which are used to attach the truck to the deck 110. Although a particular location for the light pipe matrix display 162 is illustrated in the figures, other locations are also possible.

As shown in FIG. 6B, the light pipe matrix display 162 comprises a matrix of light pipes 163. The light pipes 163 can be arranged into a matrix of rows and columns, although other arrangements are possible. As shown, each of the light pipes 163 reach the top surface of the deck 110 at a small pinhole formed in the upper surface of the deck 110. The light pipes 163 can comprise translucent light pipes. The light pipes 163 can be solid.

As shown in the bottom view of FIG. 7, the light pipes 163 of the light pipe matrix display 162 extend to a bottom surface of the deck 110. In some embodiments, the light pipes 163 may extend only partially through the deck 110. In some embodiments, a printed circuit board may be located on the underside of the deck 110 (or within the deck 110), with optical transmitters (e.g., LEDs) positioned under each light pipe 163. The display circuit board can be mounted underneath or inside the deck 110 with light pipes 163 carrying the light to the top surface of the deck 110, for example, to the pinhole sized openings provided in the top side of the deck 110 (see FIG. 6A). A matrix of optical transmitters (e.g., LEDs) associated with the light pipes and/or pinhole openings can be used to display various operational information to the user or rider. The operational information can include, for example, speed and or battery charge information. Each light pipe 163 can function as a pixel of the display 162.

FIG. 8A is a longitudinal cross-sectional perspective view of the deck 110. FIG. 8B is detail view of a longitudinal cross-section of the light pipe matrix display 162. As best seen in FIG. 8B, each light pipe 163 extends between a smaller pinhole end 163a in the top surface of the deck 110 and a larger end 163c in the bottom surface of the deck 110. A diameter of a channel 163b conically tapers between the smaller pinhole end 163a and the larger end 163c. Tapering the diameter of the light pipes 163 in a conical manner can allow for a larger, more powerful optical transmitter to be used as each pixel, and can allow for misalignment between the viewer and the optical transmitters. The total internal reflection of the light pipe 163 helps ensure the emission from the pipe is also conical, which can improve viewing angle. Since most of the vehicle's use will be during daylight, and in sunlight, a bright display may be advantageous for easy and quick viewing.

The light pipe matrix display 162 can provide one or more of the following several advantages. For example, being able to glance at a part or a component of the vehicle (e.g., the deck 110 of an electric skateboard) and view the fuel gauge or power level is more convenient and safer than, for example, having to look at a handheld device (such as a remote). Not having to refocus the eyes from long range, needed to see where you are going, to short range, to view a handheld device, reduces the time the eyes are off the road, improving safety for a user. The display 162 can be far enough from the eyes that a glance down to the display 162 does not substantially require or minimally requires the eyes to change focus from long to short range, thus the glance to the deck mounted operator interface can be done within a fraction of a second. The improvement for persons with glasses for distance viewing is even more apparent.

Further, a light pipe matrix display 162 does not significantly weaken the structure of the deck 110 as traditional embedded LED, OLED or LCD displays can. Using light pipes 163 mitigates or substantially eliminates the concern of a display not being able to be stood on or covered by a user's foot. The tiny pinholes of light pipes may be protected by, for example, the grit in the deck's grip tape. Any wear on the light pipes 163 should not affect the readability of the display.

Another advantage of a light pipe matrix display 162 is that it may be hard to view from a wider angle, away from the rider's normal riding position. A further advantage of the light pipe matrix display 162 with light pipes 163 through the component of the vehicle (e.g., deck) is that it is not obvious when the vehicle is not active. This means the vehicle can be carried in public without anyone realizing it is an electric vehicle, such as for example, an electric skateboard.

In some embodiments, a method of manufacturing the light pipes 163 into the deck 110, to form light pipes for the optical transmission of information to the board operator, comprises drilling a series of holes through the deck 110, pouring a curable liquid chemical over and in said holes, such that the liquid fills the holes and hardens to form the translucent light pipes. In some embodiments, the deck 110 can then be machined and such that the light pipes are flush with the surface of the deck 110. In some embodiments, the liquid chemical is selected from the set containing two part clear epoxy and castable polyurethane. Other materials are also useable.

Embodiments disclosed herein can be used in many electric and/or motorized vehicles or wheeled sports applications, such as road luge, electric skateboards, roller skates, inline skates, grass skiing, scooters, last leg vehicles, bicycles, recreational vehicles, etc. As used herein a “vehicle” is a device that may be used for the transport of goods or personnel. Small wheeled vehicles can include wheel chairs, electric warehouse and factory cars, buggies, autonomous vehicles. Vehicles may be unpowered, for example, as in the case of most skateboards, roller skates and street luges, or may have one or more wheels driven by electric motors. Unpowered or non-motorized vehicles may not propel a user forward, but may include other functionality, such as for example, braking. Powered vehicles can include electric vehicles, where the power supply is usually a battery, and can also include vehicles such as slot cars, dodgem cars, trolleys, tracked vehicles and trams, where a sliding contact, often a pantograph, is used to connect the vehicle to a fixed power supply such as overhead electrified mesh, wire or rails.

Embodiments disclosed herein can be used in many electric vehicles to provide push assist technology. For example, a motorized vehicle (e.g., with an electric hub motor) may be controlled by human movement. For example, the human movement of a pushing or braking motion is amplified, supplement, and/or augmented by motorized vehicle having a controller capable of determining and/or interpreting the human movement to be amplified, supplement, and/or augmented.

A used herein, “electric” has its broadest reasonable interpretation, including but not limited to some part of a vehicle has electrical components. As used herein, “motorized” has its broadest reasonable interpretation, including but not limited to driven by a motor. Motorized wheels include those driven by an electric motor. The motor may be either directly coupled to the tire, forming the hub for the tire, or it may be coupled by a mechanical power transmission, such as a gearbox or belt drive. Any number of motors may be provided on the skateboard, typically one, two or four.

It is contemplated that various combinations or sub combinations of the specific features and aspects of the embodiments disclosed above may be made and still fall within one or more of the inventions. Further, the disclosure herein of any particular feature, aspect, method, property, characteristic, quality, attribute, element, or the like in connection with an embodiment can be used in all other embodiments set forth herein. Accordingly, it should be understood that various features and aspects of the disclosed embodiments can be combined with or substituted for one another in order to form varying modes of the disclosed inventions. Thus, it is intended that the scope of the present inventions herein disclosed should not be limited by the particular disclosed embodiments described above. Moreover, while the inventions are susceptible to various modifications, and alternative forms, specific examples thereof have been shown in the drawings and are herein described in detail. It should be understood, however, that the inventions are not to be limited to the particular forms or methods disclosed, but to the contrary, the inventions are to cover all modifications, equivalents, and alternatives falling within the spirit and scope of the various embodiments described and the appended claims. Any methods disclosed herein need not be performed in the order recited. The methods disclosed herein include certain actions taken by a practitioner; however, they can also include any third-party instruction of those actions, either expressly or by implication. For example, actions such as “passing a suspension line through the base of the tongue” include “instructing the passing of a suspension line through the base of the tongue.” It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. The ranges disclosed herein also encompass any and all overlap, sub-ranges, and combinations thereof. Language such as “up to,” “at least,” “greater than,” “less than,” “between,” and the like includes the number recited. Numbers preceded by a term such as “approximately,” “about,” and “substantially” as used herein include the recited numbers, and also represent an amount close to the stated amount that still performs a desired function or achieves a desired result. For example, the terms “approximately,” “about,” and “substantially” may refer to an amount that is within less than 10% of, within less than 5% of, within less than 1% of, within less than 0.1% of, and within less than 0.01% of the stated amount. Features of embodiments disclosed herein preceded by a term such as “approximately,” “about,” and “substantially” as used herein represent the feature with some variability that still performs a desired function or achieves a desired result for that feature.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced embodiment recitation is intended, such an intent will be explicitly recited in the embodiment, and in the absence of such recitation no such intent is present. For example, as an aid to understanding, the disclosure may contain usage of the introductory phrases “at least one” and “one or more” to introduce embodiment recitations. However, the use of such phrases should not be construed to imply that the introduction of an embodiment recitation by the indefinite articles “a” or “an” limits any particular embodiment containing such introduced embodiment recitation to embodiments containing only one such recitation, even when the same embodiment includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, embodiments, or drawings, should be understood to contemplate the possibilities of including one of the terms, either of the terms, or both terms. For example, the phrase “A or B” will be understood to include the possibilities of “A” or “B” or “A and B.”

Although the present subject matter has been described herein in terms of certain embodiments, and certain exemplary methods, it is to be understood that the scope of the subject matter is not to be limited thereby. Instead, the Applicant intends that variations on the methods and materials disclosed herein which are apparent to those of skill in the art will fall within the scope of the disclosed subject matter.

What is claimed is:

1. A control system for an electric vehicle, the control system comprising:
an electronic speed controller (ESC) configured to control an electric motor operably connected to a wheel of the electric vehicle; and
an electric vehicle controller configured to monitor an operating characteristic of the electric motor, wherein the operating characteristic comprises a voltage, current, or frequency of the electric motor,
wherein the electric vehicle controller is configured to determine at least one user input based on the operating characteristic of the electric motor, wherein the user input is indicative of acceleration, maintaining constant speed, or deceleration of the electric vehicle, and
wherein the electric vehicle controller is configured to send a signal to the electronic speed controller for the electronic speed controller to control the electric motor based on the determined user input.

2. The control system of claim 1, where the electric vehicle controller is capable of determining at least one user input based on at least one of an average rate of change of speed of the wheel or a frequency of change of speed of the wheel.

3. The control system of claim 1, wherein the electric vehicle controller is connected to the electric motor to measure a back electromotive force (EMF) of the electric motor, and wherein the at least one user input is determined based on the measured back EMF.

4. The control system of any of claims 1 to 3, further comprising at least one sensor connected to the electric vehicle controller, and wherein the at least one user input is determined based on an output of the sensor.

5. The control system of claim 4, wherein the sensor is an accelerometer.

6. The control system of any of claims 1 to 5, further comprising a portable computer connection connected to the electric vehicle controller and configured to deliver an information or data signal to a portable computer, the information or data signal corresponding to operation information associated with the electric vehicle, wherein the portable computer is capable of communicating the operation information to a user.

7. The control system of claim 6, wherein the operation information comprises at least one of battery power or speed of the electric vehicle.

8. The control system of any of claims 1 to 7, wherein the electric vehicle comprises an electric skateboard.

9. The control system of any of claims 1 to 8, wherein the user input comprises a user pushing against the ground or a support surface with a foot or a stick to accelerate or decelerate the electric vehicle.

10. The control system of claim 9, wherein the user input comprises a plurality of pushes.

11. The control system of any of claims 1 to 10, wherein the user input comprises a user dragging a foot or a stick on the ground, a support surface, or the wheel of the electric vehicle to decelerate the electric vehicle.

12. The control system of any of claims 1 to 11, wherein the electric vehicle controller determines a velocity or acceleration set point based on the user input.

13. The control system of claim 12, wherein the velocity or acceleration set point is proportionally related to a frequency of the user input.

14. The control system of claim 12, wherein the velocity or acceleration set point is proportionally related to a number of user inputs.

15. The control system of any of claims 1 to 14, wherein a single controller comprises the electric vehicle controller and the electronic speed controller, such that the single controller is configured to control the electric motor and is further configured to monitor an operating characteristic of the electric motor and determine the at least one user input.

16. A control system for an electric vehicle, the control system comprising:
an electronic speed controller (ESC) configured to control an electric motor operably connected to a wheel of the electric vehicle; and
an electric vehicle controller configured to send signals to the electronic speed controller for the electronic speed controller to control the electric motor,
wherein the electric vehicle controller is configured to automatically power on using back electromotive force (EMF) generated by the electric motor when a user pushes the electric vehicle into motion from rest.

17. The control system of claim 16, wherein the electric vehicle controller is configured to power on the electronic speed controller after the electric vehicle controller automatically powers on, and wherein the electronic speed controller is powered by the back EMF.

18. The control system of any of claims 16 to 17, wherein, after automatically powering on, the electric vehicle controller transitions to battery power.

19. The control system of any of claims 17 to 18, wherein, after powering on the electronic speed controller, the electric vehicle controller transitions the electronic speed controller to battery power.

20. The control system of any of claims 16 to 19, wherein the electric motor generates back EMF when the user causes the wheel to rotate.

21. The control system of any of claims 16 to 20, wherein the control system is configured to power off the electric vehicle controller and the electronic speed controller after a period of inactivity.

22. The control system of claim 21, wherein the period of inactivity comprises a period of no rotation of the wheel.

23. The control system of claim 21, wherein the period of inactivity comprises a period of substantially no movement of the electric vehicle.

24. A user interface for an electric vehicle, the user interface comprising:
optical transmitters in the electric vehicle capable of emitting light corresponding to operation information associated with the electric vehicle; and
light pipes in the electric vehicle and corresponding to the optical transmitters, the light pipes configured to direct emitted light from the optical transmitters toward an exterior of the electric vehicle.

25. The user interface of claim 24, wherein the optical transmitters comprise light emitting diodes.

26. The user interface of any of claims 24 to 25, wherein the light pipes are solid and translucent.

27. The user interface of any of claims 24 to 26, wherein the lights pipes taper in diameter from the optical transmitters to the exterior of the electric vehicle.

28. The user interface of any of claims 24 to 27, the light pipes are arranged in a matrix pattern.

29. The user interface of any of claims 24 to 28, wherein the operation information comprises at least one of remaining battery charge associated with a battery of the electric vehicle or a speed of travel of the electric vehicle.

30. A method for controlling an electric vehicle, the method comprising:
monitoring for a user input indicative of a signal to accelerate, decelerate, or maintain a current velocity of the electric vehicle;
detecting the user input;
determining a speed or acceleration set point based on the detected user input; and
adjusting the speed or acceleration of the electric vehicle based on the determined speed or acceleration set point.

31. The method of claim 30, wherein said monitoring comprises measuring a back electromotive force (EMF) of an electric motor of the electric vehicle.

32. The method of claim 30, wherein said monitoring comprises measuring a rate of rotation of a wheel of the electric vehicle.

33. The method of claim 30, wherein said monitoring comprises analyzing an input from a sensor on the electric vehicle.

34. The method of claim 33, wherein the sensor comprises an accelerometer.

35. The method of any of claims 30 to 34, wherein the user input comprises a user pushing off the ground or a support surface with a foot or a stick to accelerate or decelerate the electric vehicle.

36. The method of any of claims 30 to 34, wherein the user input comprises a user dragging a foot or stick on the ground or the wheel of the electric vehicle to decelerate the electric vehicle.

37. The method of any of claims 30 to 36, wherein said determining a speed or acceleration set point is based on a frequency or number of user inputs detected.

38. The method of any of claims 30 to 37, wherein the electric vehicle is an electric skateboard.

39. An electric skateboard comprising:
a deck;
at least one battery on or within the deck;
an electronic speed controller connected to the at least one battery;
a motor connected to the electronic speed controller, wherein the electronic speed controller is configured regulate the speed of the motor; and
an electric vehicle controller connected to the electronic speed controller,
wherein said deck is accelerated by said electric vehicle controller sending an acceleration command to the electronic speed controller when said electric vehicle controller determines a user input corresponding to a user accelerating the skateboard.

40. The electric skateboard of claim 39, wherein the user input corresponds to a user moving the skateboard forward with respect to a direction of travel.

41. An electric skateboard comprising:
a deck and at least one battery, an electronic speed controller, an electric vehicle controller, and a motor,
wherein said deck is decelerated by said electric vehicle controller sending a deceleration command signal when said electric vehicle controller determines a user input corresponding to a user decelerating the skateboard, then communicating said braking command to said speed controller, which in turn controls said motor to contribute to the braking of said deck.

42. The electric skateboard of claim 41, wherein the user input corresponding to a user decelerating the skateboard comprises the user dragging a foot or a stick on the ground or a support surface.

43. The electric skateboard of claim 41, wherein said user input comprises a plurality of pushes, and wherein said electric vehicle controller determines a speed set point that is mathematically related to the number of said pushes.

44. The electric skateboard of claim 41, wherein said user input comprises a plurality of pushes, and wherein said electric vehicle controller determines a speed set point for motor current and thus acceleration of said skateboard, said set point being mathematically related to the wheel speed surge characteristics during said pushes.

45. The electric skateboard of claim 44, wherein said mathematical relationship is a proportionality to the average rate of change of said wheel speed during said pushes.

46. The electric skateboard of claim 44, wherein said mathematical relationship is a proportionality to the frequency of said pushes.

47. The electric skateboard of claim 44, wherein said mathematical relationship is a proportionality to both the average rate of change of said wheel speed during said pushes and the frequency of said pushes.

48. The electric skateboard of claim 41, wherein said user input is comprised of a plurality of braking actions, wherein said electric vehicle controller determines a set point for motor braking current and thus deceleration of said skateboard to a lower speed set point, said set point being mathematically related to a wheel speed of a wheel operable connected to said motor during said braking actions.

49. An electric skateboard comprising:
a deck and at least one battery, an electronic speed controller, an electric vehicle controller, and motor, optical transmitters, and light pipes,
wherein said optical transmitters are configured to communicate a status of at least one of said motor, electronic speed controller, or battery to an operator,
wherein said optical transmitters are mounted below the surface of said deck.

50. The electric skateboard of claim 49, wherein the light pipes are configured to conduct transmissions corresponding to the status through a surface of said deck.

51. The electric skateboard of any of claims 49 to 50, wherein said optical transmitters are light emitting diodes.

52. The electric skateboard of claim 51 wherein said light pipes are conically tapered to a smaller diameter leading to the surface of the deck.

53. The electric skateboard of claim 49 or 52, wherein a plurality of said optical transmitters are arranged in a matrix format.

54. A method of casting light pipes into a skateboard deck, to form light pipes for the optical transmission of information to the board operator, comprising drilling a series of holes through the deck, then pouring a curable liquid chemical over and in said holes, such that the liquid fills the holes, hardens and forms translucent light pipes, followed by machining said chemical flush with the deck surface once solidified.

55. The method in claim 54, wherein said liquid chemical is selected from the set containing two part clear epoxy and castable polyurethane.

56. An electric skateboard comprising:
a deck and at least one battery, electronic speed controller, electric vehicle controller, and motor,
wherein said electronic speed controller is capable of being powered on by said electric vehicle controller sensing an action of a user pushing the deck and powered off automatically after a period of wheel inactivity.

57. The electric skateboard of claim 56, wherein the electric skateboard does not have a power switch.

58. An electric skateboard comprising:
a deck and at least one battery, an electronic speed controller, an electric vehicle controller, motor, and at least one electromagnet interface coil,
wherein said electric vehicle controller is capable of pulsing said coil in a pulse train of variable frequency to simulate the function of a bicycle wheel permanent magnet or crank cadence permanent magnet,
wherein said pulse train of variable frequency is communicated to a cyclocomputer such that the cyclocomputer functions as a skateboard computer.

59. The electric skateboard of claim 58, wherein the cyclocomputer is not customized for use with a skateboard.

60. The electric skateboard of claim 58, where said cyclocomputer wheel speed is derived from the skateboard wheel speed by means of a divider algorithm in the electric vehicle controller.

61. The electric skateboard of claim 58, where said cyclocomputer pulse train is derived from the skateboard wheel speed by means of a peak velocity sensing algorithm in the electric vehicle controller, wherein the electric vehicle controller is capable of determining a stride rate at which the rider is pushing the board and is capable of converting the stride rate to a pushes per minute figure for output as a pulse train to the cadence coil.
